(19) United States
(12) Patent Application Publication
(10) Pub. No.: US 2013/0022171 A1
(43) Pub. Date: Jan. 24, 2013

(54) APPARATUS FOR ALIGNMENT OF MULTILAYER FILM MIRRORS FOR MONOCHROMATIC X-RAY GENERATOR AND X-RAY IMAGE DETECTING METHOD USING THE SAME

(71) Applicants: Kyong Woo Kim, Iksan-si (KR); Jae Hee Kim, Iksan-si (KR); Young Man Kwon, Iksan-si (KR); Cheol Woo Ryu, Jeongeup-si (KR)

(72) Inventors: Kyong Woo Kim, Iksan-si (KR); Jae Hee Kim, Iksan-si (KR); Young Man Kwon, Iksan-si (KR); Cheol Woo Ryu, Jeongeup-si (KR)

(73) Assignee: NANO FOCUS RAY CO., LTD, Jeonju-si, Jeollabuk-do (KR)

(21) Appl. No.: 13/637,391

(22) PCT Filed: Jul. 30, 2010
(86) PCT No.: PCT/KR2010/005024

§ 371 Date: Sep. 26, 2012

(30) Foreign Application Priority Data
May 25, 2010 (KR) 10-2010-0048423

(51) Int. Cl. G01N 23/04

(52) U.S. Cl. 378/62

(57) ABSTRACT

The present disclosure relates to an apparatus for alignment of multilayer film mirrors for a monochromatic X-ray generator and an X-ray image detecting method using the same. The apparatus for alignment of multilayer film mirrors for a monochromatic X-ray generator includes a collimator disposed between an X-ray generating unit and a detector and aligning them and limiting the radiation direction of X-ray to provide an optimum incident angle to multilayer film mirrors generating the monochromatic X-ray from the X-ray.

### CROSS REFERENCE TO RELATED APPLICATIONS AND CLAIM OF PRIORITY

This patent application is a National Phase application under 35 U.S.C. §371 of International Application No. PCT/KR2010/005024, filed on Jul. 30, 2010, which claims priority to Korean Patent Application number 10-2010-0048423, filed May 25, 2010, entire contents of which are incorporated herein by reference.

### BACKGROUND

1. Technical Field

The present disclosure relates to an apparatus for alignment of multilayer film mirrors for a monochromatic X-ray generator and an X-ray image detecting method using the same.

2. Description of the Related Art

In general, the existing X-ray imaging apparatus obtains an X-ray image using the whole energy of X-ray generated by an X-ray generating unit or some of the energy filtered through a filter.

Such an X-ray image detecting method is disadvantageous in that image quality is low and exposure to radiation is high.

In particular, for an X-ray imaging apparatus used for medical diagnosis, it is very important to reduce exposure to radiation. To solve this problem, development of an X-ray imaging apparatus using monochromatic X-ray is being attempted.

Use of monochromatic X-ray enables improvement of image quality by increasing the contrast of X-ray image as well as significant reduction of exposure to radiation. In order to develop an apparatus for generating monochromatic X-ray, fabrication of multilayer film mirrors which are key optical elements and alignment of the plural multilayer film mirrors to obtain the monochromatic X-ray energy of a specific band matching the actual system are required.

### SUMMARY

Since the existing technique of aligning plural multilayer film mirrors for a monochromatic X-ray generator requires that the incident angle of X-ray be controlled within a very narrow range (e.g., within 1°), precise adjustment of each of the multilayer film mirrors is necessary. Also, there is a difficulty in controlling the position and angle of the mirrors to obtain monochromatic X-ray with the same energy from each of the multilayer film mirrors.

Further, since the housing for aligning multilayer film mirrors is precisely engaged with a frame having holes, errors occurring during processing or assembling of the frame as well as the thickness error of the multilayer film mirrors have a significant effect on the determination of the incident angle of X-ray and it is not easy to obtain monochromatic X-ray having a desired energy band.

In addition, due to the thickness of the multilayer film mirrors and the spacing between the aligned mirrors, there occurs a region devoid of X-ray between the generated monochromatic X-rays.

In order to solve such problems, the present disclosure is directed to providing an apparatus for alignment of multilayer film mirrors for a monochromatic X-ray generator including a base jig, an elastic support and an incident angle adjustment unit, which enables precise control of the position of the multilayer film mirrors such that a user can freely and selectively choose a particular desired energy band, thus enabling obtainment of an optimized monochromatic X-ray image of the object to be detected, and an X-ray image detecting method using the same. A high-quality X-ray image with improved contrast can be obtained by using the feature of the monochromatic X-ray. In addition, exposure of patients to radiation can be greatly reduced when the apparatus for alignment of multilayer film mirrors for a monochromatic X-ray generator and the X-ray image detecting method using the same are used for medical diagnosis.

In one general aspect, the present disclosure provides an apparatus for alignment of multilayer film mirrors for a monochromatic X-ray generator including a collimator disposed between an X-ray generating unit generating and irradiating X-ray to a subject and a detector obtaining an image of the subject using monochromatic X-ray incident from plural multilayer film mirrors and aligning them and limiting the radiation direction of X-ray to provide an optimum incident angle to the multilayer film mirrors generating the monochromatic X-ray from the X-ray, wherein the alignment apparatus includes: a base jig arranging the multilayer film mirrors in an upright manner; an elastic support supporting one side of the multilayer film mirrors standing upright on the base jig; and an incident angle adjustment unit adjusting the incident angle of the X-ray by pushing the rear side of the multilayer film mirrors elastically supported by the elastic support.

In the apparatus for alignment of multilayer film mirrors for a monochromatic X-ray generator according to the present disclosure, the base jig may include: plural horizontal frames disposed in a direction perpendicular to a baseline connecting the centers of the X-ray generating unit and the detector, each being spaced vertically apart from each other by the height of the multilayer film mirrors and being spaced horizontally apart from each other by the length thereof, and having plural installation pins spaced at regular intervals such that the upper and lower ends of the multilayer film mirrors are installed by being inserted at the center thereof; and plural vertical frames fixed to a main housing connecting both ends of the plural horizontal frames.

In the apparatus for alignment of multilayer film mirrors for a monochromatic X-ray generator according to the present disclosure, the spacing between the installation pins may be larger than the thickness of the multilayer film mirrors such that the multilayer film mirrors can be tilted horizontally between the installation pins to precisely adjust the incident angle.

And, in the apparatus for alignment of multilayer film mirrors for a monochromatic X-ray generator according to the present disclosure, the elastic support may include: a rod engaged via a screw with and penetrating the main housing fixed to one end of the base jig; a moving plate connected to one penetrating end of the rod and moving horizontally together with the rod; and plural elastic supporting pins connected to one end of the moving plate and elastically supporting each of the plural multilayer film mirrors in contact therewith.

In the apparatus for alignment of multilayer film mirrors for a monochromatic X-ray generator according to the present disclosure, the plural multilayer film mirrors may be reduced in length along a direction toward the elastic support, and the plural elastic supporting pins may be reduced in length toward the center of the plural multilayer film mirrors correspondingly thereto such that they are adhered closely to each of the multilayer film mirrors.

And, in the apparatus for alignment of multilayer film mirrors for a monochromatic X-ray generator according to the present disclosure, the elastic supporting pins may be equipped with protrusions protruding as elastically supported by springs at the end thereof

In the apparatus for alignment of multilayer film mirrors for a monochromatic X-ray generator according to the present disclosure, the incident angle adjustment unit may include: a guide rail connected to the main housing and disposed outside the base jig; a slider sliding toward the multilayer film mirrors as coupled with the guide rail and having plural adjusting pins so as to adjust the incident angle by pushing the elastic support toward the multilayer film mirrors; and a fine control knob disposed outside the guide rail as opposed to the elastic support and finely sliding the slider as coupled with the slider.

And, in the apparatus for alignment of multilayer film mirrors for a monochromatic X-ray generator according to the present disclosure, a spring may be disposed at the guide rail beside the elastic support to elastically support an end of the slider.

In the apparatus for alignment of multilayer film mirrors for a monochromatic X-ray generator, the elastic supporting pins of the elastic support may be disposed at four positions to support the corners of the multilayer film mirrors and the adjusting pins of the incident angle adjustment unit may also be disposed at four positions to press the four corners correspondingly thereto.

In another general aspect, the present disclosure provides an X-ray image detecting method using the apparatus for alignment of multilayer film mirrors for a monochromatic X-ray generator, wherein a pair of multilayer film mirrors are arranged symmetrically with respect to a baseline connecting the centers of an X-ray generating unit and a detector such that one of them obtains lower monochromatic energy and the other obtains higher monochromatic energy and a collimator disposed at the end of the alignment apparatus selectively selects one of the two monochromatic energies.

In another general aspect, the present disclosure provides an X-ray image detecting method using the apparatus for alignment of multilayer film mirrors for a monochromatic X-ray generator, wherein plural multilayer film mirrors are precisely arranged at such positions that the region devoid of monochromatic X-ray incident from the plural multilayer film mirrors due to the thickness of the multilayer film mirrors and the spacing between the arranged multilayer film mirrors can be decreased (or minimized).

In another general aspect, the present disclosure provides an X-ray image detecting method using the apparatus for alignment of multilayer film mirrors for a monochromatic X-ray generator, wherein an X-ray generating unit and a detector are disposed on the same base, and a collimator aligning the X-ray generating unit and the detector obtaining an image of a subject using monochromatic X-ray incident from plural multilayer film mirrors and limiting the radiation direction of X-ray to provide an optimum incident angle to the multilayer film mirrors scans the subject to obtain the image of the subject while it rotates along an arc of a predetermined radius.

The apparatus for alignment of multilayer film mirrors for a monochromatic X-ray generator according to the present disclosure and the X-ray image detecting method using the same are advantageous in that the alignment apparatus including a base jig, an elastic support and an incident angle adjustment unit can precisely align the position of multilayer film mirrors. Thus, since a user can freely and selectively choose a particular desired energy band, an optimized monochromatic X-ray image of the object to be detected can be obtained. Furthermore, a high-quality X-ray image with improved contrast can be obtained by using the feature of the monochromatic X-ray. In addition, exposure of patients to radiation can be greatly reduced when the apparatus for alignment of multilayer film mirrors for a monochromatic X-ray generator and the X-ray image detecting method using the same are used for medical diagnosis.

### BRIEF DESCRIPTION OF DRAWINGS

FIG. 1 is a schematic perspective view of a monochromatic X-ray generator according to an embodiment of the present disclosure.

FIG. 2 and FIG. 3 are perspective views of an apparatus for alignment of multilayer film mirrors for a monochromatic X-ray generator according to an embodiment of the present disclosure.

FIG. 4 is a front view of an apparatus for alignment of multilayer film mirrors for a monochromatic X-ray generator according to an embodiment of the present disclosure.

FIG. 5 is a perspective view of a base jig of an apparatus for alignment of multilayer film mirrors for a monochromatic X-ray generator according to an embodiment of the present disclosure.

FIG. 6 is a partial perspective view of an incident angle adjustment unit of an apparatus for alignment of multilayer film mirrors for a monochromatic X-ray generator according to an embodiment of the present disclosure.

FIG. 7 is a perspective view of an elastic support of an apparatus for alignment of multilayer film mirrors for a monochromatic X-ray generator according to an embodiment of the present disclosure.

FIGS. 8-10 are schematic views illustrating an X-ray image detecting method using an apparatus for alignment of multilayer film mirrors for a monochromatic X-ray generator according to an embodiment of the present disclosure.

### DETAILED DESCRIPTION

Hereinafter, the embodiments of the present disclosure will be described in detail with reference to accompanying drawings.

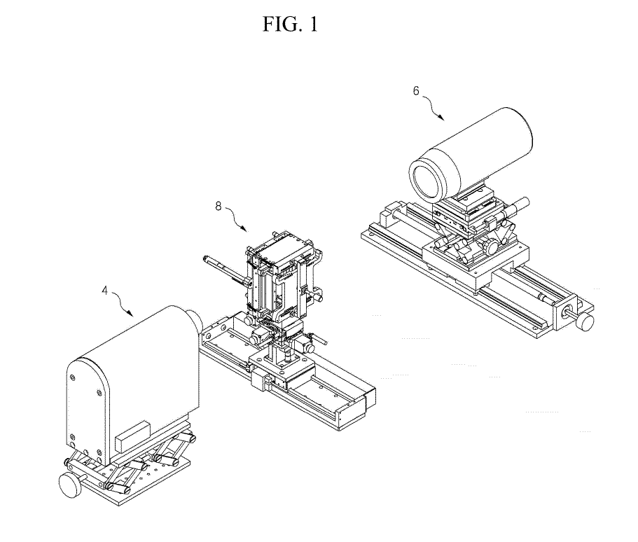

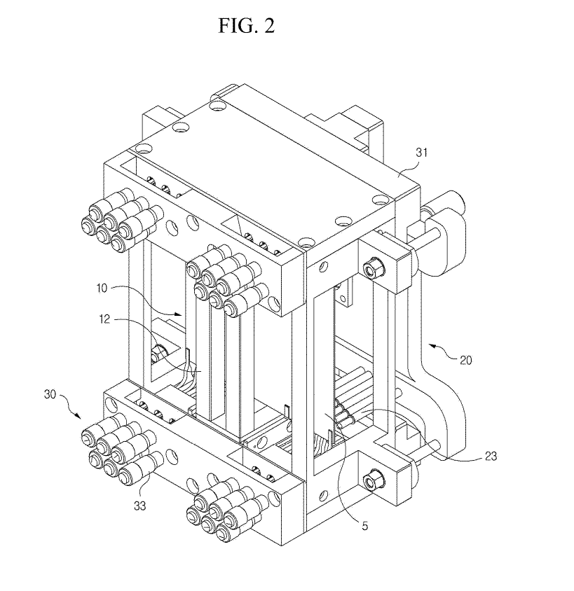

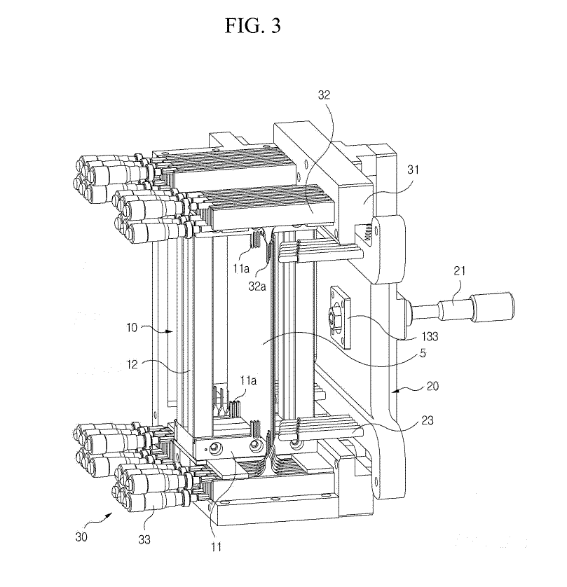

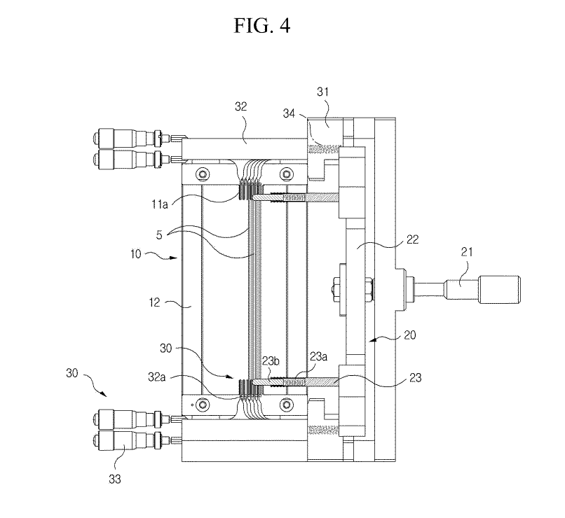

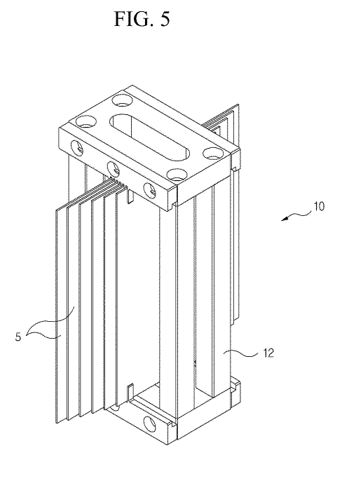

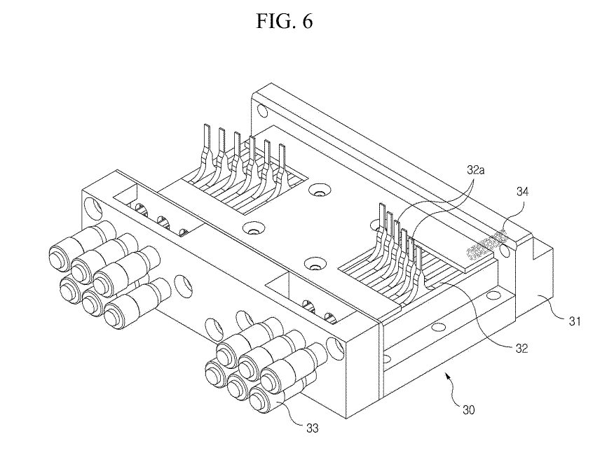

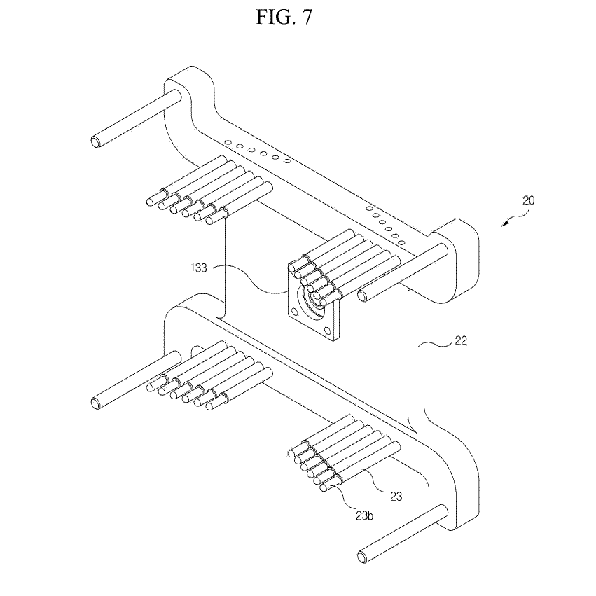

As shown in FIGS. 1-7, an apparatus for alignment of multilayer film mirrors for a monochromatic X-ray generator according to an embodiment of the present disclosure includes a collimator (8) disposed between an X-ray generating unit (4) generating and irradiating X-ray to a subject (2) and a detector (6) obtaining an image of the subject (2) using monochromatic X-ray incident from plural multilayer film mirrors (5) and aligning them and limiting the radiation direction of X-ray to provide an optimum incident angle to the multilayer film mirrors (5) generating the monochromatic X-ray from the X-ray, wherein the alignment apparatus includes a base jig (10) arranging the multilayer film mirrors (5) in an upright manner, an elastic support (20) supporting one side of the multilayer film mirrors (5) standing upright on the base jig (10) and an incident angle adjustment unit (30) adjusting the incident angle of the X-ray by pushing the rear side of the multilayer film mirrors (5) elastically supported by the elastic support (20).

The base jig (10) includes plural horizontal frames (11) disposed in a direction perpendicular to a baseline connecting the centers of the X-ray generating unit (4) and the detector (6), each being spaced vertically apart from each other by the height of the multilayer film mirrors (5) and being spaced horizontally apart from each other by the length thereof, and having plural installation pins (11a) spaced at regular intervals such that the upper and lower ends of the multilayer film mirrors (5) are installed by being inserted at the center thereof, and plural vertical frames (12) fixed to a main housing (15) connecting both ends of the plural horizontal frames (11).

The spacing between the installation pins (11a) is larger than the thickness of the multilayer film mirrors (5) such that the multilayer film mirrors (5) can be tilted horizontally between the installation pins (11a) to precisely adjust the incident angle.

Specifically, the base jig (10) is disposed detachably in pairs at the positions where the multilayer film mirrors (5) are desired to be aligned and, after the alignment is completed, the multilayer film mirrors (5) may be fixed to the base jig (10) by applying epoxy.

The elastic support (20) includes a rod (21) engaged via a screw with and penetrating the main housing (15) fixed to one end of the base jig (10), a moving plate (22) connected to one penetrating end of the rod (21) by a connecting member (133) and moving horizontally together with the rod (21), and plural elastic supporting pins (23) connected to one end of the moving plate (22) and elastically supporting each of the plural multilayer film mirrors (5) in contact therewith.

The plural multilayer film mirrors (5) are reduced in length along a direction toward the elastic support (20), and the plural elastic supporting pins (23) are reduced in length toward the center of the plural multilayer film mirrors (5) correspondingly thereto such that they are adhered closely to each of the multilayer film mirrors (5).

And, the elastic supporting pins (23) are equipped with protrusions (23b) protruding as elastically supported by springs (23a) at the end thereof.

The elastic supporting pins (23) elastically press the multilayer film mirrors (5) with a tension of tens to dozens of gf to align the multilayer film mirrors (5) at positions having an incident angle for obtaining the desired monochromatic X-ray.

The incident angle adjustment unit (30) includes a guide rail (31) connected to the main housing (15) and disposed outside the base jig (10), a slider (32) sliding toward the multilayer film mirrors (5) as coupled with the guide rail (31) and having plural adjusting pins (32a) so as to adjust the incident angle by pushing the elastic support (20) toward the multilayer film mirrors (5), and a fine control knob (33) disposed outside the guide rail (31) as opposed to the elastic support (20) and finely sliding the slider (32) as coupled with the slider (32).

And, a spring (34) is disposed at the guide rail (31) beside the elastic support (20) to elastically support an end of the slider (32).

The elastic supporting pins (23) of the elastic support (20) are disposed at four positions to support the corners of the multilayer film mirrors (5) and the adjusting pins (32a) of the incident angle adjustment unit (30) are also disposed at four positions to press the four corners correspondingly thereto.

The incident angle adjustment unit (30) may use a manual micrometer or a motor-driven actuator as the fine control knob (33) to slide the slider (32) for precise control of the multilayer film mirrors (5).

The adjusting pins (32a) may be formed of a material having high rigidity and may be arranged as steps with a thickness of not greater than 1 mm so that they can be moved between the multilayer film mirrors (5).

After the plural multilayer film mirrors (5) are aligned with the installation pins (11a) of the base jig (10) roughly at the desired positions, the multilayer film mirrors (5) are elastically supported by pushing the elastic supporting pins (23) toward the opposite side. Then, the multilayer film mirrors (5) are pushed by the adjusting pins (32a) at the opposite side to precisely align the multilayer film mirrors (5) at the desired positions. As a result, the multilayer film mirrors (5) have an incident angle for obtaining the desired monochromatic X-ray.

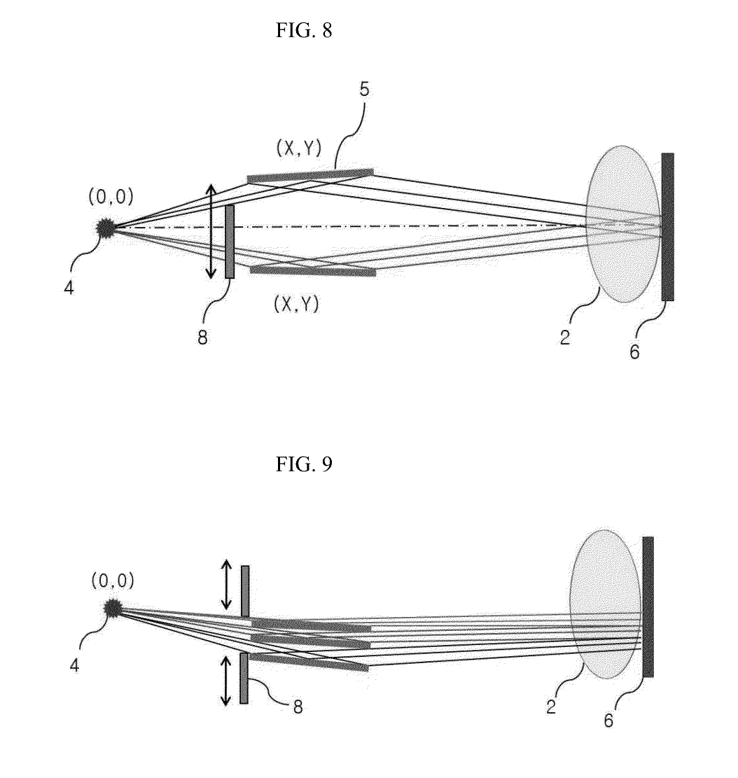

For example, as shown in FIG. 8, a pair of multilayer film mirrors (5) may be arranged symmetrically with respect to a baseline connecting the centers of an X-ray generating unit (4) and a detector (6) such that one of them obtains lower monochromatic energy and the other obtains higher monochromatic energy, and a collimator (8) disposed at the end of the alignment apparatus selectively may select one of the two monochromatic energies.

Alternatively, as shown in FIG. 9, plural multilayer film mirrors (5) may be precisely arranged at such positions that the region devoid of monochromatic X-ray incident from the plural multilayer film mirrors (5) due to the thickness of the multilayer film mirrors (5) and the spacing between the arranged multilayer film mirrors (5) may be decreased (or minimized).

When the subject (2) has a thickness of 10 mm or smaller, a spatial resolution of approximately 30 μm can be obtained.

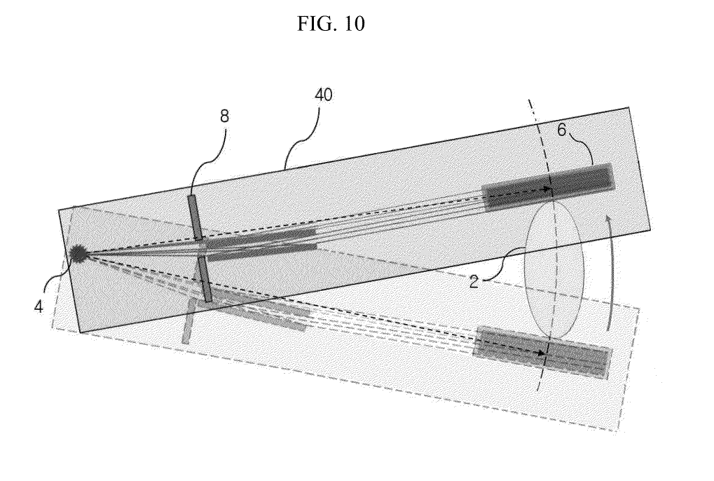

Alternatively, as shown in FIG. 10, an X-ray generating unit (4) and a detector (6) may be disposed on the same base (40), and a collimator (8) aligning the X-ray generating unit (4) and the detector (6) obtaining an image of a subject (2) using monochromatic X-ray incident from plural multilayer film mirrors (5) and limiting the radiation direction of X-ray to provide an optimum incident angle to the multilayer film mirrors (5) may scan the subject (2) to obtain the image of the subject (2) while it rotates along an arc of a predetermined radius.

As described above, in accordance with the present disclosure, the alignment apparatus including a base jig, an elastic support and an incident angle adjustment unit can precisely align the position of multilayer film mirrors. Thus, since a user can freely and selectively choose a particular desired energy band, an optimized monochromatic X-ray image of the object to be detected can be obtained. Furthermore, a high-quality X-ray image with improved contrast can be obtained by using the feature of the monochromatic X-ray. In addition, exposure of patients to radiation can be greatly reduced when the apparatus for alignment of multilayer film mirrors for a monochromatic X-ray generator and the X-ray image detecting method using the same are used for medical diagnosis.

Those skilled in the art will appreciate that the conceptions and specific embodiments disclosed in the foregoing description may be readily utilized as a basis for modifying or designing other embodiments for carrying out the same purposes of the present disclosure. Those skilled in the art will also appreciate that such equivalent embodiments do not depart from the spirit and scope of the disclosure as set forth in the appended claims.

1. A monochromatic X-ray generator comprising:
an X-ray generating unit generating and irradiating X-ray to a subject;
a detector obtaining an image of the subject using monochromatic X-ray incident from plural multilayer film mirrors;
a collimator disposed between the X-ray generating unit and the detector, the collimator comprising the plural multilayer film mirrors generating the monochromatic X-ray from the X-ray and an apparatus for aligning the plural multi layer film mirrors and limiting the radiation direction of X-ray to provide an optimum incident angle to the multilayer film mirrors the alignment apparatus comprising:
a base jig arranging the multilayer film mirrors in an upright manner;
an elastic support supporting one side of the multilayer film mirrors standing upright on the base jig; and
an incident angle adjustment unit adjusting an incident angle of the X-ray by pushing the rear side of the multilayer film mirrors elastically supported by the elastic support.

2. The monochromatic X-ray generator of claim 1, wherein the base jig comprises:
plural horizontal frames disposed in a direction perpendicular to a baseline connecting centers of the X-ray generating unit and the detector, each being spaced vertically apart from each other by the height of the multilayer film mirrors and being spaced horizontally apart from each other by the length thereof, and having plural installation pins spaced at regular intervals such that the upper and lower ends of the multilayer film mirrors are installed by being inserted at the center thereof; and
plural vertical frames fixed to a main housing connecting both ends of the plural horizontal frames.

3. The monochromatic X-ray generator of claim 2, wherein a spacing between the installation pins is larger than a thickness of the multilayer film mirrors such that the multilayer film mirrors can be tilted horizontally between the installation pins to adjust the incident angle.

4. The monochromatic X-ray generator of claim 1, wherein the elastic support comprises:
a rod engaged via a screw with and penetrating the a main housing fixed to one end of the base jig;
a moving plate connected to one penetrating end of the rod and moving horizontally together with the rod; and
plural elastic supporting pins connected to one end of the moving plate and elastically supporting each of the plural multilayer film mirrors in contact therewith.

5. The monochromatic X-ray generator of claim 4, wherein the plural multilayer film mirrors are reduced in length along a direction toward the elastic support, the plural elastic supporting pins are reduced in length toward the center of the plural multilayer film mirrors correspondingly thereto such that they are adhered closely to each of the multilayer film mirrors, and the elastic supporting pins are equipped with protrusions protruding as elastically supported by springs at the end thereof.

6. The monochromatic X-ray generator of claim 1, wherein the incident angle adjustment unit comprises:
a guide rail disposed outside the base jig;
a slider sliding toward the multilayer film mirrors as coupled with the guide rail and having plural adjusting pins so as to adjust the incident angle by pushing the elastic support toward the multilayer film mirrors; and
a fine control knob disposed outside the guide rail as opposed to the elastic support and finely sliding the slider as coupled with the slider; and
a spring is disposed at the guide rail beside the elastic support to elastically support an end of the slider.

7. The monochromatic X-ray generator of claim 6, wherein the elastic support comprises elastic supporting pins, the elastic supporting pins of the elastic support are disposed at four positions to support the corners of the multilayer film mirrors, and the adjusting pins of the incident angle adjustment unit are also disposed at four positions to press the four corners correspondingly thereto.

8. An X-ray image detecting method, comprising utilizing the monochromatic X-ray generator of claim 1, wherein a pair of multilayer film mirrors are arranged symmetrically with respect to a baseline connecting the centers of the X-ray generating unit and the detector such that one of them obtains lower monochromatic energy and the other obtains higher monochromatic energy and the collimator disposed at the end of the alignment apparatus selectively selects one of the two monochromatic energies.

9. An X-ray image detecting method, comprising utilizing the monochromatic X-ray generator of claim 1, wherein plural multilayer film mirrors are arranged at such positions that a region devoid of monochromatic X-ray incident from the plural multilayer film mirrors due to a thickness of the multilayer film mirrors and a spacing between the arranged multilayer film mirrors are decreased.

10. An X-ray image detecting method, comprising utilizing the monochromatic X-ray generator of claim 1, wherein the X-ray generating unit and the detector are disposed on the same base, and the collimator and the detector scans the subject to obtain the image of the subject while they rotates along an arc of a predetermined radius.

11. An apparatus for aligning plural multi layer film mirrors of a collimator of an X-ray generator comprised of an X-ray generating unit, a detector and the collimator, comprising:
a base jig arranging the multilayer film mirrors in an upright manner;
an elastic support supporting one side of the multilayer film mirrors standing upright on the base jig; and
an incident angle adjustment unit adjusting the incident angle of the an X-ray by pushing the rear side of the multilayer film mirrors elastically supported by the elastic support.

12. The apparatus of claim 11, wherein the base jig comprises:
plural horizontal frames disposed in a direction perpendicular to a baseline connecting centers of the X-ray generating unit and the detector, each being spaced vertically apart from each other by the height of the multilayer film mirrors and being spaced horizontally apart from each other by the length thereof, and having plural installation pins spaced at regular intervals such that the upper and lower ends of the multilayer film mirrors are installed by being inserted at the center thereof; and
plural vertical frames fixed to a main housing connecting both ends of the plural horizontal frames.

13. The apparatus of claim 12, wherein a spacing between the installation pins is larger than a thickness of the multilayer film mirrors such that the multilayer film mirrors can be tilted horizontally between the installation pins to adjust the incident angle.

14. The apparatus of claim 11, wherein the elastic support comprises:
a rod engaged with and penetrating a main housing fixed to one end of the base jig;
a moving plate connected to one penetrating end of the rod and moving horizontally together with the rod; and
plural elastic supporting pins connected to one end of the moving plate and elastically supporting each of the plural multilayer film mirrors in contact therewith.

15. The apparatus of claim 14, wherein the plural multilayer film mirrors are reduced in length along a direction toward the elastic support, the plural elastic supporting pins are reduced in length toward the center of the plural multilayer film mirrors correspondingly thereto such that they are adhered closely to each of the multilayer film mirrors, and the elastic supporting pins are equipped with protrusions protruding as elastically supported by springs at the end thereof

16. The apparatus of claim 11, wherein the incident angle adjustment unit comprises:
a guide rail disposed outside the base jig;
a slider sliding toward the multilayer film mirrors as coupled with the guide rail and having plural adjusting pins so as to adjust the incident angle by pushing the elastic support toward the multilayer film mirrors;
a fine control knob disposed outside the guide rail as opposed to the elastic support and finely sliding the slider as coupled with the slider; and
a spring disposed at the guide rail beside the elastic support to elastically support an end of the slider.

17. The apparatus of claim 16, wherein the elastic support comprises elastic supporting pins, the elastic supporting pins of the elastic support are disposed at four positions to support the corners of the multilayer film mirrors, and the adjusting pins of the incident angle adjustment unit are disposed at four positions to press the four corners correspondingly thereto.

18. An X-ray image detecting method, comprising utilizing the apparatus of claim 11, wherein a pair of multilayer film mirrors are arranged symmetrically with respect to a baseline connecting centers of the X-ray generating unit and the detector such that one of them obtains lower monochromatic energy and the other obtains higher monochromatic energy and the collimator disposed at the end of the alignment apparatus selectively selects one of the two monochromatic energies.

19. An X-ray image detecting method, comprising utilizing the apparatus of claim 11, wherein the plural multilayer film mirrors are arranged at such positions that a region devoid of monochromatic X-ray incident from the plural multilayer film mirrors due to a thickness of the multilayer film mirrors and a spacing between the arranged multilayer film mirrors are decreased.

20. An X-ray image detecting method, comprising utilizing the apparatus of claim 11, wherein the X-ray generating unit and the detector are disposed on the same base, and the collimator and the detector scan the subject to obtain the image of the subject while they rotate along an arc of a predetermined radius.
